(19) United States
(12) Patent Application Publication
(10) Pub. No.: US 2010/0118376 A1
(43) Pub. Date: May 13, 2010

(54) MULTI-LAYERED PHOTOCHROMIC SHEET AND PHOTOCHROMIC GLASS PREPARED THEREFROM

(76) Inventors: Dong-Joo Kwon, Daejeon Metropolitan City (KR); Woo-Sung Kim, Chungcheongnam-do (KR); Young-Jun Hong, Daejeon Metropolitan City (KR)

Correspondence Address: MCKENNA LONG & ALDRIDGE LLP, 1900 K STREET, NW, WASHINGTON, DC, 20006, US

(21) Appl. No.: 12/450,703

(22) PCT Filed: Apr. 8, 2008
(86) PCT No.: PCT/KR2008/001984

§ 371 Date: Oct. 8, 2009

(30) Foreign Application Priority Data
Apr. 9, 2007 (KR) 10-2007-0034629

(51) Int. Cl. G02F 1/17

(52) U.S. Cl. 359/241

(57) ABSTRACT

The present invention relates to a multi-layered photochromic sheet and a photo chromic glass prepared therefrom. In particular, the present invention relates to a multi-layered photochromic sheet having excellent durability by reducing a decomposition rate of photochromic dye, in which two or more photochromic films consisting of an oxygen or moisture shielding barrier layer and photochromic layer are stacked, compared to a conventional mono layered film. Further, the present invention relates to a photochromic glass having excellent durability and appearance, in which the multi-layered photochromic sheet is disposed between two glasses, and to a glass for vehicles or buildings using the same.

### TECHNICAL FIELD

The present invention relates to a multi-layered photochromic sheet and a photochromic glass prepared therefrom. More particularly, the present invention relates to a multi-layered photochromic sheet having excellent durability and an effect of preventing reduction of photochromism by reducing decomposition and dispersion of photochromic dye, and to a photochromic glass having excellent durability and appearance, comprising the photochromic film.

This application claims priority from Korea Patent Application No. 10-2007-34629 filed on Apr. 9, 2007 in the KIPO, the disclosure of which is incorporated herein by reference in its entirety.

### BACKGROUND ART

Since general glasses directly transmit sunlight, interior temperature in a vehicle or house is abruptly increased, and a driver and passenger are exposed to the direct ray of light, which restricts their view.

To prevent the above problems, it has been suggested that photochromic films are applied to the glass for vehicle.

A cross-sectional view of a conventional photochromic glass 500 for vehicles is shown in FIG. 3. As shown in FIG. 3, the conventional photochromic glass 500 has a structure of disposing a monolayered photochromic film 530 between two glasses 511 and 512 by means of adhesion films 521 and 522.

However, since the photochromic substances are decomposed too fast by light, the average life span of the photochromic substance is not sufficient, and the decomposed photochromic substances develop yellow or red color to change the original color of glass. That is, it is difficult to apply the monolayered photochromic film to a photochromic glass for vehicles.

Accordingly, there is a need to develop photochromic films having excellent durability, as compared to the conventional monolayered photochromic film.

### DISCLOSURE

### Technical Problem

In order to solve the problems in the prior art, it is an object of the present invention to provide a multi-layered photochromic sheet having excellent durability and an effect of preventing reduction of photochromism by suppressing dispersion even after partial decomposition of photochromic dye.

Further, it is another object of the present invention to provide a photochromic glass for vehicles or building comprising the multi-layered photochromic sheet, which has excellent durability and appearance.

The above objects and other objects of the present invention can be achieved by the present invention described below.

### Technical Solution

In order to achieve the above objects, the present invention provides a multi-layered photochromic sheet, which has a structure comprising i) an oxygen or moisture shielding barrier film, and ii) at least two or more photochromic films including photochromic layers on at least one side of the oxygen or moisture shielding barrier film, and the barrier film is stacked on the outermost photochromic layer of the photochromic film.

The multi-layered photochromic sheet is preferably formed by a lamination method, in particular, a dry lamination method by heat press.

Further, the present invention provides a photochromic glass comprising the multi-layered photochromic sheet between two glasses.

### Advantageous Effects

As described above, the present invention provides a multi-layered photochromic sheet having excellent durability and an effect of preventing reduction of photochromism even after partial decomposition of photochromic dye, as compared to the conventional monolayered photochromic film.

Further, the present invention provides a photochromic glass for vehicles comprising the multi-layered photochromic sheet, which has excellent durability and appearance by preventing that the decomposed photochromic substances develop yellow or red color to change the original color of glass.

### DESCRIPTION OF DRAWINGS

FIG. 1 is a cross-sectional view showing an example of the structure of a multi-layered photochromic sheet (a) and a photochromic glass (b) prepared therefrom according to the present invention;

FIG. 2 is a cross-sectional view showing another example of the structure of a multi-layered photochromic sheet (a) and a photochromic glass (b) prepared therefrom according to the present invention; and

FIG. 3 is a cross-sectional view of a photochromic glass prepared from a conventional monolayered photochromic film.

### NUMERAL REFERENCES

100, 200: multi-layered photochromic sheet

112, 212˜216: oxygen or moisture shielding barrier film

121˜125, 221˜225: photochromic film

300, 400, 500: photochromic glass

311, 312, 411, 412, 511, 512: glass

321, 322, 421, 422, 521, 522: adhesion films

530: mono-layered photochromic film

### BEST MODE

Hereinafter, the present invention will be described in detail.

The present inventors had conducted studies on photochromic glasses for vehicles and found that when an oxygen or moisture shielding barrier layer and a photochromic layer were alternately formed, they delay the chain reaction which discolors photochromic substances and improve durability and the life span of photochromic film, completing the present invention.

The multi-layered photochromic sheet of the present invention has a structure comprising i) an oxygen or moisture shielding barrier film, and ii) at least two or more photochromic films including photochromic layers on at least one side of the oxygen or moisture shielding barrier film, where the barrier film is stacked on the outermost photochromic layer of the photochromic film.

The barrier film can be produced by depositing or coating oxygen or moisture shielding barrier on one side or both sides of plastic resin film, and the oxygen or moisture shielding barrier is preferably stacked on the plastic resin film to be exposed to the outside.

The barrier film functions to prevent the deterioration of photochromic effect, which is caused by the change of photochromic substances to other substances due to oxygen or moisture. That is, since a ring structure in the molecule becomes open due to external energy such as sunlight and UV, the photochromic dye is generally discolored. At this time, the photochromic dye loses its photochromic function by attack of surrounding oxygen or water. Accordingly, to effectively shield oxygen or water that deteriorates the durability of photochromic dye, the oxygen or moisture shielding barrier layer is introduced in the present invention.

It is preferable that the barrier film has a thickness of 30 to 40 μm so as to maintain its barrierability and not to inhibit the processability upon coating the photochromic layer.

Examples of the plastic resin may include PET (polyethylene terephthalate), PE (polyester), PEN (polyethylene naphthalate), PEEK (polyetherether ketone), PC (polycarbonate), PES (polyethersulphone), PI (polyimide), PAR (polyarylate), PCO (polycyclicolefin) and polynorbornene, and mixtures thereof may be used.

The barrier layer may be produced by a method such as vacuum thermal evaporation, e-beam evaporation, and sputtering, or a sol-gel coating method using gas-barrier materials, such as oxide and nitride materials.

Examples of the oxide materials may include silicon oxide, boric oxide, phosphorus oxide, sodium oxide, potassium oxide, lead oxide, titanium oxide, magnesium oxide and barium oxide, and example of the nitride materials may include silicon nitride.

The barrier layer may be produced by forming plasma on the polymer resin film using organic or inorganic vapor being polymerizable by plasma-enhanced chemical vapor deposition (PECVD), and then depositing oxide or nitride thereon.

For example, in the case of using silicon oxide as the barrier layer, a monomer such as tetramethoxysilane (TMOS), tetraethoxysilane (TEOS), hexamethyldisiloxane (HMDSO), and tetramethylsilane (TMS), and oxygen or oxygen/argon mixture may be used.

The barrier layer preferably has a thickness of 100 nm to 5 μm. In the case where the thickness is less than 100 nm, it is difficult to form the film without a pinhole. In the case where the thickness is more than 5 μm, a long time is required for the processing and transparency is reduced.

The photochromic layer may be produced by coating a photochromic resin composition on the barrier layer.

The photochromic resin composition contains a photochromic dye. That is, the photochromic resin composition may contain a binder resin, a plasticizer and a photochromic dye, and an organic solvent, including alcohol solvent, BTX aromatic solvent or the like, maybe used upon coating on the barrier layer.

The binder resin may be preferably selected from, but is not specifically limited to, polyvinyl butyral resin, ethylenevinylacetate resin and ethylenemethylmethacrylate.

The alcohol solvent is a solvent having a high boiling point and being highly volatile, in particular, cyclohexanone, cellosolves or furfuryl alcohol.

Examples of the BTX aromatic solvent may include benzene, toluene, and xylene.

The photochromic resin composition may further include a typical dye. The typical dye functions to compensate the initial color that is hardly developed by only the photochromic dye, and simultaneously to cover distorted color or spot which may occur upon the decomposition of photochromic dye. The kind of the typical dye is not specifically limited.

The typical dye is preferably contained in an amount of 0.01 to 0.2 parts by weight, based on 100 parts by weight of the photochromic resin composition. In the case where the content is less than 0.01 parts by weight, it is difficult to ensure desirable effects. In the case where the content is more than 0.2 parts by weight, an undesirable dark color is developed to diminish the effect of photochromic dye, and precipitation may occur due to compatibility with the solvent, which problematically causes spots.

The photochromic resin composition may further include 0.1 to 3 parts by weight of UV absorbent, 0.1 to 3 parts by weight of heat stabilizer, 0.01 to 1 parts by weight of light stabilizer, 0.1 to 1 parts by weight of levelling agent or the like.

The photochromic resin composition may be controlled depending on its application to the photochromic film, and is not limited to the composition and content.

According to one embodiment of the present invention, the photochromic resin composition may include 60 to 100 parts by weight of polyvinyl butyral resin, 5 to 40 parts by weight of glycol plasticizer, and 0.01 to 1 parts by weight of photochromic dye, and 50 to 200 parts by weight of alcohol solvent and 50 to 250 parts by weight of BTX aromatic solvent may be used upon coating on ‘the barrier layer.

The polyvinyl butyral resin preferably has a weight average molecular weight of 40,000 to 120,000.

Further, according to another embodiment of the present invention, the photochromic resin composition may include 60 to 100 parts by weight of ethylene vinylacetate resin, 0.01 to 1 parts by weight of photochromic dye, and 0.01 to 0.2 parts by weight of typical dye, and 50 to 250 parts by weight of BTX aromatic solvent maybe used upon coating on the barrier layer.

The ethylene vinylacetate resin preferably includes vinylacetate in a content of 30 to 45% by weight. In the case where the content of vinylacetate is less than 30% by weight, solubility in the solvent is rapidly decreased not to prepare a coating solution. In the case where the content of vinylacetate is more than 45% by weight, glass transition temperature is increased by the high content of vinylacetate, as well as the decomposed acetate is increased, which may deteriorate durability of photochromic dye.

According to still another embodiment of the present invention, the photochromic resin composition may include 60 to 100 parts by weight of ethylenemethylmethacrylate and 0.01 to 1 parts by weight of photochromic dye, and 50 to 250 parts by weight of BTX aromatic solvent may be used upon coating on the barrier layer.

The photochromic film is a film which the photochromic layer is stacked on the oxygen or moisture shielding barrier film.

The photochromic film is coated to have a final thickness of 30 to 150 μm using a general comma coater, considering the concentration of photochromic resin composition, and then dried under 105° C. to produce a photochromic film.

The method of producing the photochromic film may be controlled depending on the application condition, and any method known to those skilled in the art may be employed.

The multi-layered photochromic sheet includes two or more of the photochromic film, preferably two to five of photochromic film in a stacked structure. Upon lamination, the barrier film may be further laminated on the surface of the outermost photochromic layer, which does not contact with other films and is exposed to the outside.

The multi-layered photochromic sheet may preferably have a thickness of 100 to 330 μm, but is not limited thereto, may be adjusted depending on the application. At this time, lamination may be performed by a heat press method using a hot press, hot roller or the like. The hot press lamination may be adjusted depending on film thickness and the type of roll used in the lamination, and preferably performed in a temperature range of 80-130° C. and a pressure range of 1 MPa-10 MPa.

The multi-layered photochromic sheet has an effect of shielding the radical chain decomposition during the decomposition of photochromic dye after the initial exposure to the outside, and an effect of improving the reduction in transmittance which is generated by optical loss due to midway reflection, by controlling the entire thickness upon the production of photochromic glass.

Further, the multi-layered photochromic sheet of the present invention may have barrier layers on the both surfaces, and may have a stacked structure of stacking two or more barrier layers and photochromic layers alternatively.

The photochromic glass of the present invention is a glass comprising the multi-layered photochromic sheet.

The photochromic glass may comprise the multi-layered photochromic sheet between glasses. At this time, the glass and photochromic sheet may be adhered to each other by coating with an adhesive or by using an adhesion film. However, in the case where a carboxyl group or metal catalyst is present in the adhesive composition, durability may be seriously deteriorated due to properties of photochromic dye. Therefore, adhesives such as acryl, urethane, and silicon containing carboxylic acid or metal catalyst are not desirable, and the adhesion film is preferably used.

Examples of the adhesion film may include polyvinyl butyral resin, ethylenevinylacetate resin and ethylenemethylmethacrylate resin.

The photochromic glass preferably has a thickness of 1.8 to 2.5 mm. In the case where the thickness is less than 1.8 mm, since the photochromic glass is too thin, it may be damaged upon the bonding process. In the case where the thickness is more than 2.5 mm, the glass is not suitable to a window size of vehicles to be applied.

The photochromic glass is preferably applied to the window of vehicles, but is not limited thereto.

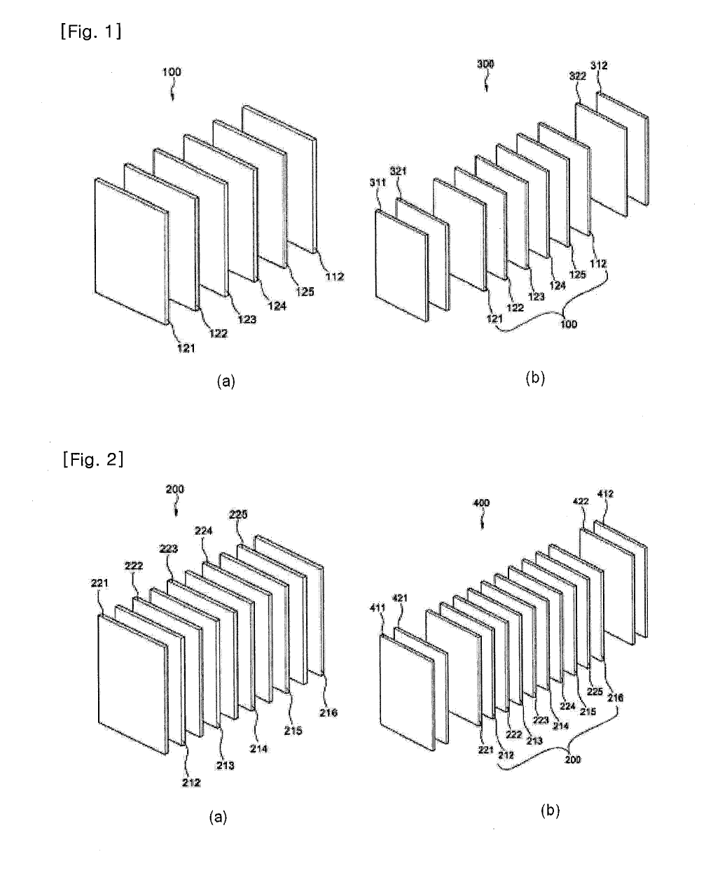

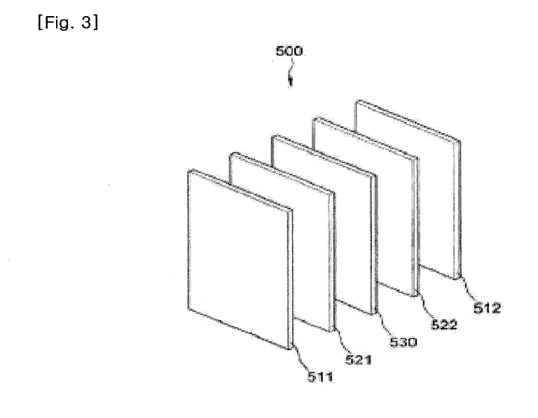

A cross-sectional view showing a multi-layered photochromic sheet (a) containing five photochromic films and a photochromic glass (b) prepared therefrom is shown in FIG. 1 as an example of according to the present invention.

The multi-layered photochromic sheet 100 of FIG. 1(a) has a stacked structure of laminating five photochromic films 121˜125 and one oxygen or moisture shielding barrier film 112. Both external sides of the stacked structure are oxygen or moisture shielding barrier films, and thus function to shield oxygen or water which deteriorates durability of photochromic dye.

The photochromic glass 300 of FIG. 1(b) contains the multi-layered photochromic sheet 100 between two glasses 311 and 312, and the glasses 311 and 312 and photochromic sheet 100 are adhered by means of adhesion films 321 and 322.

A cross-sectional view showing a multi-layered photochromic sheet (a) containing five photochromic films and a photochromic glass (b) prepared therefrom is shown in FIG. 2 as another example of according to the present invention.

The multi-layered photochromic sheet 200 of FIG. 2(a) has a stacked structure of inserting one oxygen or moisture shielding barrier film 212˜215 between photochromic films in the stacked structure of FIG. 1(a). The photochromic sheet having such a structure is able to more effectively shield oxygen or water.

The photochromic glass 400 of FIG. 2(b) contains the multi-layered photochromic sheet 200 between two glasses 411 and 412, and the glasses 411 and 412 and photochromic sheet 200 are adhered by means of adhesion films 421 and 422.

### Mode for Invention

Hereinafter, although the preferred embodiments of the present invention have been disclosed for illustrative purposes, those skilled in the art will appreciate that various modifications, additions and substitutions are possible, without departing from the scope and spirit of the invention as disclosed in the accompanying claims.

### Example

### Example 1

<Preparation of Photochromic Resin Composition>

28 parts by weight of S-2075 (manufactured by Solution) as a glycol plasticizer, 105 parts by weight of butylcellosolve, 105 parts by weight of toluene, 0.35 parts by weight of Palatinate purple (manufactured by James Robinson) as a photochromic dye, 0.02 parts by weight of Papilion Blue (manufactured by Eastwell) as a typical dye, 0.2 parts by weight of Tinuvin 1130 (manufactured by Ciba) as a UV absorbent, 1.0 parts by weight of Tinuvin 123 (manufactured by Ciba) as a light stabilizer, 0.8 parts by weight of HP1010 (manufactured by Ciba) as a heat stabilizer, 0.1 parts by weight of Tego 270 (manufactured by Degussa) as a levelling agent were added to a reactor, and stirring was performed at 60° C. for 30 min to completely solubilize. Then, 70 parts by weight of polyvinyl butyral resin was added thereto, and stirred at the same temperature for about 2 hrs to completely solubilize. The solution was filtered to obtain a photochromic resin composition.

<Production of Multi-Layered Photochromic Sheet>

The prepared photochromic resin composition was coated to a thickness of 30 μm on one side of PET oxygen shielding barrier film with a thickness of 30 μm onto which silicon oxide as inorganic oxide is deposited, so as to produce a photochromic film with a thickness of 60 μm. Five of the prepared photochromic film were stacked, and then the PET oxygen shielding barrier film with to a thickness of 30 μm, onto which silicon oxide as inorganic oxide is deposited, was stacked on the outside of the photochromic film where the photochromic layer of the photochromic film is exposed to the outside. At this time, the deposition surface (barrier layer) is faced to the outside, so as to produce a multi-layered photochromic sheet comprising five photochromic films by laminating.

<Production of Photochromic Glass>

The produced multi-layered photochromic sheet was inserted between two glasses, and then PVB film as an adhesion film was inserted. Then, vacuum press lamination was performed under the conditions of 140° C. and 10 MPa to produce a photochromic glass.

### Example 2

Experiment was performed in the same manner as in Example 1, except using a photochromic resin composition prepared by the following method.

<Preparation of Photochromic Resin Composition>

210 parts by weight of toluene, 0.35 parts by weight of Palatinate purple (manufactured by James Robinson) as a photochromic dye, 0.02 parts by weight of Papilion Blue (manufactured by Eastwell) as a typical dye, 0.2 parts by weight of Tinuvin 1130 (manufactured by Ciba) as a UV absorbent, 1.0 parts by weight of Tinuvin 123 (manufactured by Ciba) as a light stabilizer, 0.8 parts by weight of HP1010 (manufactured by Ciba) as a heat stabilizer, 0.1 parts by weight of Tego 270 (manufactured by Degussa) as a levelling agent were added to a reactor, and stirring was performed at 60° C. for 30 min to completely solubilize. Then, 70 parts by weight of ethylenevinylacetate resin (content of vinylacetate: 40%, manufactured by Exxonmobile) was added thereto, and stirred at the same temperature for about 2 hrs to completely solubilize. The solution was filtered to obtain a photochromic resin composition.

### Example 3

Experiment was performed in the same manner as in Example 1, except that upon producing the multi-layered photochromic sheet, the photochromic resin composition was coated on one surface of oxygen shielding barrier film, to laminate two photochromic films with a thickness of 150 μm.

### Comparative Example 1

Experiment was performed in the same manner as in Example 1, except that upon producing the photochromic film, a release film was used instead of the oxygen shielding barrier film, and the photochromic resin composition was coated on one surface of the release film to produce a monolayered photochromic film with a thickness of 300 μm.

### Comparative Example 2

Experiment was performed in the same manner as in Example 2, except that upon producing the photochromic film, a release film was used instead of the oxygen shielding barrier film, and the photochromic resin composition was coated on one surface of the release film to produce a monolayered photochromic film with a thickness of 300 μm.

### Experimental Example

Physical properties of the multi-layered photochromic sheets produced in Examples 1 to 3 and Comparative Examples 1 to 2, and photochromic glasses produced therefrom were measured by the following method, and the results are shown in the following Table 1.

(1) Weathering Test

A weathering test was performed using an accelerated weathering tester ATLAS UV 2000 and a UVA 340 lamp at an irradiance of 0.77 W/m ²/nm in accordance with ASTM G154-99.

Exposure Cycle
8 hrs 60(±3)° C. Black Panel Temperature
4 hrs Condensation 50(±3)° C. Black Panel Temperature

The above procedure was repeated, and then optical density was measured. And, time for the absorbance At the initial λmax to decrease by half (T1/2) was measured.

(2) Optical Density (OD)

The cured coating films were irradiated with UV at a wavelength of 365 nm (1.35 mW/cm²) for 5 min, and the emitted light was immediately measured using a UV-Vis detector in a colored state and a decolorized state. At this time, ΔOD was calculated in accordance with the following Mathematical Formula 1.

ΔODmax=log{transmittance (%) in decolorized state/transmittance (%) in colored state} [Mathematical Formula 1]

(3) Coloring/Decoloring Rate (t_{1/2})

The time was measured, when the transmittance at λₘₐₓ of the samples, which were exposed to UV under the same conditions as in the measurement of optical density (OD), reached the half of those in completely decolorized state after removing the light source.

TABLE 1

| | Example | Example | Example | Comparative | Comparative |
|---|---|---|---|---|---|
| | 1 | 2 | 3 | Example 1 | Example 2 |
| T_{1/2} (hr) | 3000 | 3500 | 2000 | 1000 | 1500 |
| λₘₐₓ | 610 | 625 | 610 | 610 | 625 |
| Δ ODₘₐₓ | 0.82 | 0.95 | 0.82 | 0.82 | 0.95 |
| t_{1/2} (sec) | 24 | 12 | 23 | 23 | 12 |

As shown in Table 1, it can be seen that Examples 1 to 3 using the multi-layered photochromic sheet comprising the oxygen or moisture shielding barrier film and multi-layered photochromic film according to the present invention exhibited excellent durability, compared to Comparative Examples 1 and 2 using a release film (general PET film) instead of the oxygen or moisture shielding barrier film.

1. A multi-layered photochromic sheet having a structure comprising i) an oxygen or moisture shielding barrier film, and ii) at least two or more photochromic films including photochromic layers on at least one side of the oxygen or moisture shielding barrier film, wherein the barrier film is stacked on the outermost photochromic layer of the photochromic film.

2. The multi-layered photochromic sheet according to claim 1, wherein the stacked structure of barrier film and photochromic film is formed by heat press lamination.

3. The multi-layered photochromic sheet according to claim 2, wherein the lamination is performed in a temperature range of 80˜130° C. and a pressure range of 1 MPa˜10 MPa.

4. The multi-layered photochromic sheet according to claim 1, wherein the barrier film is prepared by depositing oxide or nitride on one side or both sides of plastic resin film including at least one selected from the group consisting of polyethylene terephthalate, polyester, polyethylene naphthalate, polyetherether ketone, polycarbonate, polyethersulphone, polyimide, polyarylate, polycyclicolefin and polynorbornene.

5. The multi-layered photochromic sheet according to claim 4, wherein the oxide is at least one selected from the group consisting of silicon oxide, boric oxide, phosphorus oxide, sodium oxide, potassium oxide, lead oxide, titanium oxide, magnesium oxide and barium oxide.

6. (canceled)

7. The multi-layered photochromic sheet according to claim 4, wherein the nitride is silicon nitride.

8. The multi-layered photochromic sheet according to claim 1, wherein the barrier film has a thickness of 30 to 40 μm.

9. The multi-layered photochromic sheet according to claim 1, wherein the photochromic layer comprises a photochromic composition containing a binder resin, a plasticizer and a photochromic dye, and is coated on the barrier layer using an organic solvent.

10. The multi-layered photochromic sheet according to claim 9, wherein the binder resin is selected from a polyvinyl butyral resin, an ethylenevinylacetate resin and ethylenemethylmethacrylate.

11. The multi-layered photochromic sheet according to claim 9, wherein the photochromic layer consists of the photochromic resin composition including 60 to 100 parts by weight of polyvinyl butyral resin, 5 to 40 parts by weight of glycol plasticizer, and 0.01 to 1 parts by weight of photochromic dye, and is coated using 50 to 200 parts by weight of alcohol solvent and 50 to 250 parts by weight of BTX aromatic solvent.

12. The multi-layered photochromic sheet according to claim 11, wherein the polyvinyl butyral resin has a weight average molecular weight of 40,000 to 120,000.

13. The multi-layered photochromic sheet according to claim 9, wherein the photochromic layer consists of the photochromic resin composition including 60 to 100 parts by weight of ethylenevinylacetate resin and 0.01 to 1 parts by weight of photochromic dye, and is coated using 50 to 250 parts by weight of BTX aromatic solvent.

14. The multi-layered photochromic sheet according to claim 13, wherein the ethylenevinylacetate resin contains vinylacetate in a content of 30 to 45% by weight.

15. The multi-layered photochromic sheet according to claim 9, wherein the photochromic layer consists of the photochromic resin composition including 60 to 100 parts by weight of ethylenemethylmethacrylate and 0.01 to 1 parts by weight of photochromic dye, and is coated using 50 to 250 parts by weight of BTX aromatic solvent.

16. The multi-layered photochromic sheet according to claim 9, wherein the photochromic resin composition further includes 0.1 to 3 parts by weight of UV absorbent, 0.1 to 3 parts by weight of heat stabilizer, 0.01 to 1 parts by weight of light stabilizer, 0.1 to 1 parts by weight of levelling agent or 0.01 to 0.2 parts by weight of typical dye as an additive.

17. The multi-layered photochromic sheet according to claim 1, wherein the photochromic sheet has a thickness of 100 to 330 μm.

18. The multi-layered photochromic sheet according to claim 1, wherein two or more of the barrier layer and photochromic layer are alternately stacked, and both surfaces of the sheet are the barrier layers.

19. A photochromic glass comprising the multi-layered photochromic sheet according to claim 1 between two glasses.

20. The photochromic glass according to claim 19, wherein an adhesive layer or adhesion film is contained between the glass and the multi-layered photochromic sheet.

21. (canceled)

22. The photochromic glass according to claim 19, wherein the photochromic glass is a window glass for vehicle.
